(19) United States
(12) Patent Application Publication
(10) Pub. No.: US 2026/0260597 A1
(43) Pub. Date: Sep. 3, 2026

(54) DISTRIBUTED DRIVE CIRCUIT AND DISPLAY DEVICE WITH THE SAME

(71) Applicant: HUAYUAN SEMICONDUCTOR (SHENZHEN) LIMITED COMPANY, Shenzhen, Guangdong (CN)

(72) Inventors: Junyue Sun, Shenzhen, Guangdong (CN); Yujun Wang, Shenzhen, Guangdong (CN); Yuanlei Wang, Shenzhen, Guangdong (CN); Yuting Fang, Shenzhen, Guangdong (CN); Xiang Xia, Shenzhen, Guangdong (CN)

(21) Appl. No.: 18/881,751

(22) PCT Filed: Apr. 21, 2023
(86) PCT No.: PCT/CN2023/089714

§ 371 Date: Jan. 7, 2025

(30) Foreign Application Priority Data
Aug. 16, 2022 (CN) 202210986107.2

(51) Int. Cl. G09G 3/32

(52) U.S. Cl. CPC G09G 3/32; G09G 2320/0626

(57) ABSTRACT

Provided are a distributed drive circuit and a display device with the same. The drive circuit comprises a control circuit, drive circuit array, command control interface and read-back line. The drive circuit array comprises a plurality of drive circuit groups, each group comprises a plurality of drive circuits; the control circuit is used for sending control signal and command signal to the drive circuit; the command control interface is arranged in the control circuit, and the command control interface is used for outputting the control signal and command signal for transmission to the drive circuit; the command control interface is in serial connection with the plurality of drive circuits; the drive circuit is used for driving LED, and is also used for generating read-back data to the control circuit; and the read-back line is used for transmitting the read-back data generated by the drive circuit back to the control circuit.

### TECHNICAL FIELD

The application relates to the technical field of display equipment, in particular to a distributed drive circuit and display device with the same.

### BACKGROUND

LED is used in many electronic display devices, such as computers, televisions, mobile devices, smart phones, projection systems, billboards and so on.

A large number of LED units may be included in the display device, and these LED units can be arranged in the display area in the form of an array. In the prior art, the data control of each row of LED drive circuits in the array is parallel. That is, the LED drive circuits in each row share the same data control line and ground, and the data control line and ground are buses. Please refer to FIG. 1, which shows both of them need to be connected to each drive circuit. Therefore, in a Single Layer PCB, one of the two buses needs the help of jumper wires (circled in FIG. 1) to be connected to the drive circuit. In other terms, the existing display device can not well support a Single Layer PCB without the help of jumper wires.

The following are the downsides of using jumper wires: jumper wires get loose and aged over time, reducing the circuit's reliability. Moreover, using jumper wires raises the cost of the circuit.

### SUMMARY OF THE INVENTION

The application provides a distributed drive circuit and display device with the same, aiming at addressing the issue that the Single Layer PCB cannot be well supported without the use of jumper wires in the prior art.

In order to solve the above technical problems, the application provides the following technical solutions.

According to a first aspect of the present application, the present application provides a distributed drive circuit, including a control circuit, a drive circuit array, a command control interface and a read-back line; wherein
the drive circuit array includes a plurality of drive circuit groups, each drive circuit group includes a plurality of drive circuits;
the control circuit is used for sending a control signal and a command signal to the drive circuit;
the command control interface is arranged in the control circuit, and the command control interface is used for outputting the control signal and command signal sent by the control circuit for transmission to the drive circuit;
the command control interface is in serial connection with the plurality of drive circuits in each drive circuit group;
the drive circuit is used for driving LED in response to the control signals, and is also used for generating read-back data to the control circuit in response to the command signal; and
the read-back line is used for transmitting the read-back data generated by the drive circuit back to the control circuit.

Preferably, the distributed drive circuit further includes serial communication lines, wherein the serial communication line is in one-to-one correspondence with the drive circuit group; and
the control circuit, the serial communication line and the read-back line form a loop, and the drive circuit of each group is connected in series in the serial communication line, so that the read-back data of the drive circuit is transmitted to the read-back line via the serial communication line and then transmitted to the control circuit via the read-back line.

Preferably, the distributed drive circuit further includes a buffer component, wherein the buffer component is connected in a control command line, and is used for enhancing a driving capability of the control circuit.

Preferably, the buffer component includes a plurality of buffers, and the buffer is in one-to-one correspondence with the drive circuit group; and
the buffer is arranged between the control circuit and a first drive circuit of each drive circuit group.

Preferably, the buffer component includes a plurality of buffers, and the buffer is in one-to-one correspondence with the drive circuit group; and
the buffer is arranged in the drive circuit.

Preferably, a driving delay of the drive circuit is less than a preset value.

Preferably, the distributed drive circuit further includes a first delay compensation unit arranged in the control circuit;
wherein the first delay compensation unit is used for compensating the driving delay of the drive circuit.

Preferably, the distributed drive circuit further includes a second delay compensation unit arranged in the control circuit;
wherein the second delay compensation unit is used for compensating the driving delay of the drive circuit.

Preferably, the distributed drive circuit further includes a first delay detection unit, wherein
the first delay detection unit is in one-to-one correspondence with the drive circuit; and the first delay detection unit is used to detect a delay of the control signal and command signal of the corresponding drive circuit, and feed back a detection value to the second delay compensation unit, enabling the second delay compensation unit to compensate the driving delay of the drive circuit according to the detection value.

Preferably, the distributed drive circuit further includes a third delay compensation unit, wherein the third delay compensation unit is in one-to-one correspondence with the drive circuit; and
the third delay compensation unit is used for compensating the driving delay of the corresponding drive circuit.

Preferably, the distributed drive circuit further includes a second delay detection unit, wherein the second delay detection unit is in one-to-one correspondence with the drive circuit; and
an output end of the second delay detection unit is connected with an input end of the third delay compensation unit, and an input end of the second delay detection unit is connected with an input end and an output end of the buffer; and
the second delay detection unit is used to detect the delay of the control signal and command signal of the corresponding drive circuit, and feed back the detection value to the third delay compensation unit, enabling the third delay compensation unit to compensate the driving delay of the drive circuit according to the detection value.

Preferably, the distributed drive circuit further includes a fourth delay compensation unit and a fifth delay compensation unit; wherein
the fourth delay compensation unit is arranged in the control circuit;
the fifth delay compensation unit is in one-to-one correspondence with the drive circuit, and the fifth delay compensation unit is arranged in the drive circuit; and
the fourth delay compensation unit and the fifth delay compensation unit are configured to jointly compensate the driving delay of the drive circuit.

According to a second aspect of the present application, the present application provides a display device with a distributed drive circuit, including a distributed drive circuit and an LED zone array; wherein
the LED zone array includes a plurality of groups of LED zones, and each group of LED zones includes a plurality of LED zones;
the LED zone is in one-to-one correspondence with the drive circuit; and
the distributed drive circuit is the distributed drive circuit described in any one of the above.

According to the distributed drive circuit and display device with the same provided by the application, the command control interface is connected in series with a plurality of drive circuits in each drive circuit group, i.e., the data control line is no longer a bus and does not conflict with the ground line, so that a single-layer PCB can be well supported without the help of jumper wires. Moreover, the use of jumper wire is omitted, which can not only avoid the problem of poor reliability due to the looseness and aging of jumper wire, but also save costs.

Because the control circuit needs to control a large number of drive circuit, there will be a problem of insufficient driving capability, which will affect the quality of dimming data signals. In an optional solution of the present application, with the arrangement of the buffer in the control command line, the driving capability of the control circuit can be enhanced, and the quality of the optical data signal can be ensured under the condition of driving a large number of drive circuit.

In an optional solution of the present application, the buffer is built in each drive circuit, so that the driving capability requirement of the control circuit is reduced under the condition of driving a large number of drive circuits. In addition, it is built in the drive circuit, which avoids the need to install additional buffer separately, and further reduces the cost.

In an optional solution of the present application, the driving delay of the drive circuits is compensated by the delay compensation unit, so that the driving delay among each drive circuit in each drive circuit group can be shortened and driven almost simultaneously, and the quality of dimming data signals is further improved.

In an alternative solution of the present application, the delay of the drive circuit is detected by the delay detection unit, and the detection value is fed back to the delay compensation unit. This allows the delay compensation to be more accurate and the quality of the dimming data signal to be higher.

### BRIEF DESCRIPTION OF THE DRAWINGS

In order to explain the technical solution of the embodiments of this application more clearly, the drawings described in the description of the embodiments of this application will be briefly introduced below. Obviously, the drawings in the present application and their accompanying detailed description are directed to merely exemplary embodiments of the application. For those of ordinary skill in this field, other drawings may be obtained according to these drawings without any creative effort.

FIG. 1 is a schematic diagram of a drive circuit in the prior art.

FIG. 2 is a schematic diagram of a distributed drive circuit according to an embodiment of the present application.

FIG. 3 is a schematic diagram of a drive circuit according to an embodiment of the present application.

FIG. 4 is a schematic diagram of a distributed drive circuit according to a preferred embodiment of the present application.

FIG. 5 is a schematic diagram of a distributed drive circuit according to another preferred embodiment of the present application.

FIG. 6 is a schematic diagram of a distributed drive circuit according to another preferred embodiment of the present application.

FIG. 7 is a schematic diagram of a distributed drive circuit according to another preferred embodiment of the present application.

FIG. 8 is a schematic diagram of delay compensation processing by a control circuit according to an embodiment of the present application.

FIG. 9 is a schematic diagram of a distributed drive circuit according to another preferred embodiment of the present application.

FIG. 10 is a schematic diagram of a drive circuit according to another preferred embodiment of the present application.

FIG. 11 is a schematic diagram of a drive circuit according to another preferred embodiment of the present application.

FIG. 12 is a circuit diagram of a display device with the distributed drive circuit according an embodiment of the present application.

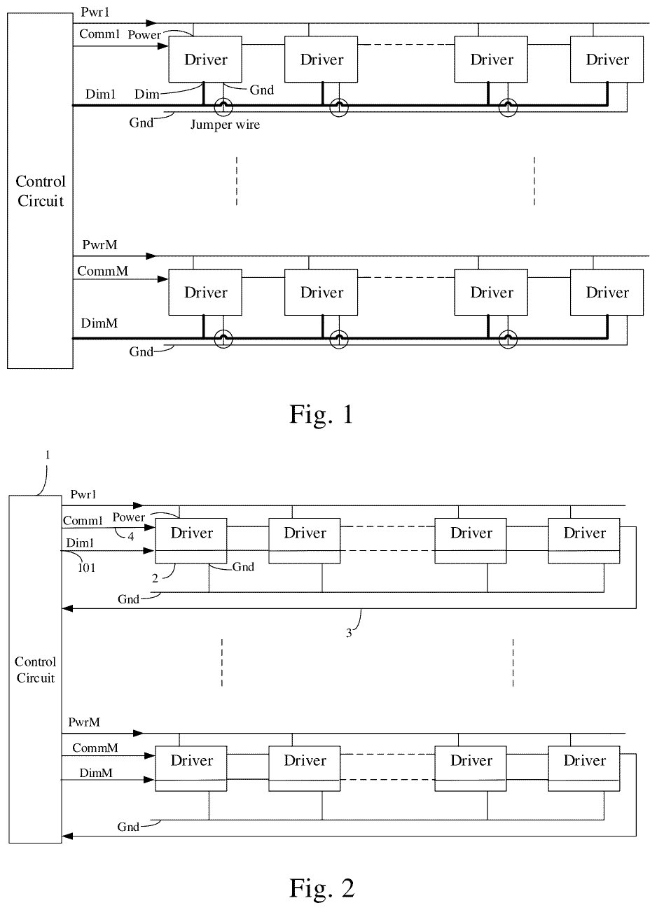

### REFERENCE SIGNS IN THE DRAWINGS ARE AS FOLLOWS

1. Control circuit;
101. Command control interface;
2. Drive circuit;
3. Read-back line;
4. Serial communication line;
5. Buffer;
6. First delay compensation unit;
7. Second delay compensation unit;
8. First delay detection unit;
9. Third delay compensation unit;
10. Second delay detection unit;
11. Fourth delay compensation unit;
12. Fifth delay compensation unit;
13. LED zone.

### DETAILED DESCRIPTION OF PREFERRED EMBODIMENTS

The technical solutions in the embodiments of the present application will be clearly and completely described below with reference to the drawings in the embodiments of this application. Obviously, the described embodiments are merely part of the embodiments of this application, not all of them. Based on the embodiments in this application, all other embodiments obtained by those of ordinary skill in the art without creative effort belong to the protection scope of this application.

For the description of the specification of the present application, it should be understood that the orientations or positional relationships indicated by the terms “upper part”, “lower part”, “upper end”, “lower end”, “lower surface” and “upper surface” and the like are based on the orientations or positional relationships shown in the attached drawings, only for convenience of describing the present application and simplifying the description, and do not indicate or imply that the said device or element must have a specific orientation, be constructed or operated in a particular orientation, and therefore cannot be understood as a limitation of the present application.

For the description of the specification of the present application, the terms “first” and “second” are used for descriptive purposes only and cannot be understood as indicating or implying relative importance or implicitly indicating the number of technical features indicated. Thus, a feature defined by “first” or “second” may explicitly or implicitly includes one or more of the features.

For the description of the present application, “plurality” means plural, such as two, three, four, etc., unless otherwise specifically defined.

For the description of the specification of the present application, unless otherwise stated, the term “connection” and the like should be understood in a broad sense. For example, they may be fixedly connected, detachably connected or integrally connected, or may be mechanically connected or electrically connected, or can communicate with one another. Or they may be directly connected or indirectly connected through an intermediate medium. Or it may be internal communication of two elements or the interaction between two elements. For those of ordinary skill in the art, the specific meanings of the above terms in the present application may be understood in specific situations.

The technical solution of the present application will be described in detail with specific embodiments. The following specific embodiments can be combined with one another, and the same or similar concepts or processes may not be repeated in some embodiments.

In an embodiment, a distributed drive circuit is provided, which includes a control circuit 1, a drive circuit array, a command control interface 101, and a read-back line 3. Please refer to FIG. 2. The drive circuit array includes a plurality of drive circuit groups, and each drive circuit group includes a plurality of drive circuit 2 (Driver). The drive circuit may be arranged in a two-dimensional array (e.g., arranged in rows and columns). The control circuit 1 is used to send a control signal and a command signal to the drive circuit 2. The command control interface 101 is arranged in the control circuit 1, and the command control interface 101 is used for outputting the control signal and command signals sent by the control circuit for transmission to the drive circuit 2. The drive circuit 2 is used to drive the LED in response to the control signal, and also used to generate read-back data to the control circuit 1 in response to the command signal. The read-back line 3 is used to transmit the read-back data generated by the drive circuit 2 back to the control circuit 1.

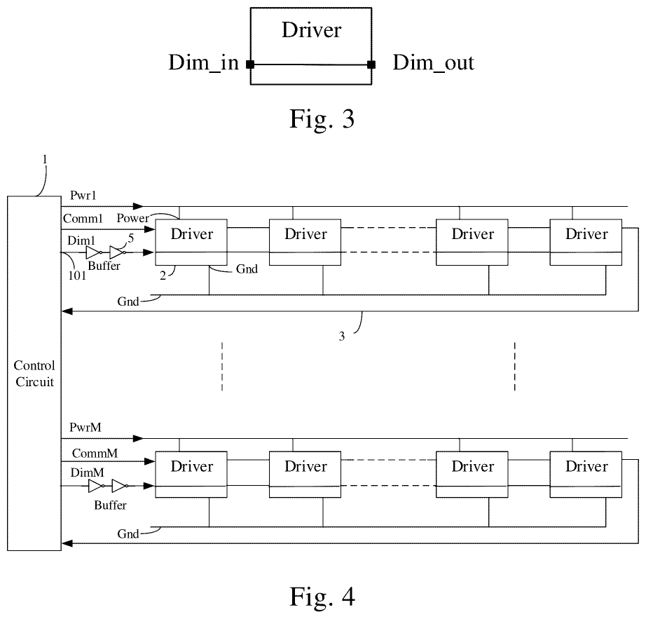

Specifically, the command control interface 101 is connected in series with the plurality of drive circuits 2 in each drive circuit group, such as Dim1 . . . DimM shown in FIG. 2, which passes through each drive circuit 2, as shown in FIG. 3. In this way, the connection line between the command control interface 101 and each drive circuit 2 is no longer a bus, but only a ground bus, and it can be arranged on the single-layer PCB without the help of jumper wires, which not only saves cost, but also improves the reliability of the circuit.

In an embodiment, in order to facilitate the transmission of read-back data, the distributed drive circuit further includes serial communication line 4 (Comm1 . . . CommM), as shown in FIG. 2. The serial communication line 4 is in one-to-one correspondence with the drive circuit group. The control circuit 1, serial communication line 4 and read-back line 3 form a loop, and the serial communication line 4 connects the drive circuits of each drive circuit group in series. This allows the read-back data of each drive circuit 2 to be transmitted to the read-back line 3, and then the read-back data is transmitted back to the control circuit 1 via the read-back line 3.

In an embodiment, in order to enhance the driving energy of the control circuit 1, it may further include a buffer component connected in a control command line for enhancing the driving capability of the control circuit.

In an embodiment, the buffer component may be arranged on the connecting line between the control circuit and the drive circuit. Specifically, the buffer component includes a plurality of buffers 5, and the buffer 5 is in one-to-one correspondence with the drive circuit group. The buffer 5 can be arranged between the control circuit and the first drive circuit 2 of each drive circuit group, as shown in FIG. 4.

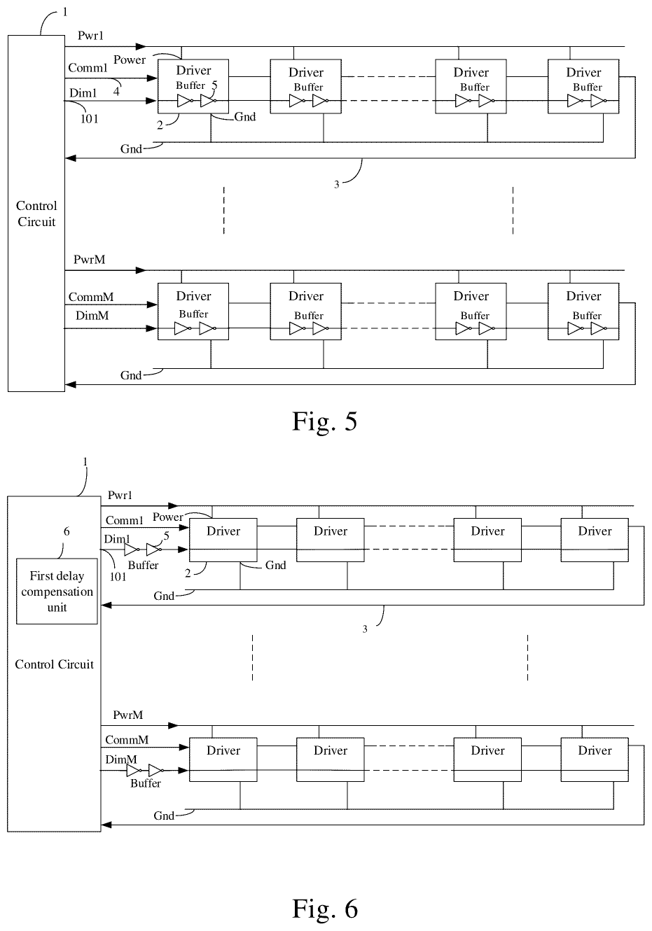

In an embodiment, the buffer component can be built in the drive circuit. Specifically, the buffer component includes a plurality of buffers 5, and the buffer 5 is in one-to-one correspondence with the drive circuit 2. The buffer 5 is arranged in the drive circuit 2, as shown in FIG. 5.

In an embodiment, because the command control interface and the drive circuit are connected in series, the time for the drive circuit far from the control circuit to receive signals is certainly longer than that for the drive circuit near the control circuit to receive signals. Therefore, in order to improve the dimming quality, the driving delay of the drive circuit should be controlled to be less than a preset value. The smaller the driving delay, the more synchronous the LED, and the better the dimming quality.

Since the delay of the distributed drive circuit with the buffer is longer, the delay compensation of the distributed drive circuit with the buffer is described below. Although the delay of the distributed drive circuit without buffer is relatively small, it can also be compensated, and the delay compensation can also be designed with reference to the embodiment with buffer.

In an embodiment, on the basis of setting the buffer, in order to reduce the delay, the delay can be controlled by selecting the buffer. Preferably, the delay can be shortened by compensating the delay, and the effect is better. The delay compensation can be realized in many ways, which will be described in detail with specific examples below.

Specifically, the delay compensation can be arranged in the control circuit, and the delay of each drive circuit is compensated by the control circuit. In different embodiments, the delay compensation may also be arranged in the drive circuit, and each drive circuit compensates its own delay. In another embodiment, the delay compensation may also be arranged in the control circuit and the drive circuit at the same time, and the two can work together to complete the delay compensation. Specifically, the compensation ratio of the control circuit and the drive circuit can be designed differently according to needs.

In an embodiment, on the basis that the buffer component is arranged on the connecting line between the control circuit and the drive circuit, the delay compensation unit may also be arranged in the control circuit. Specifically, the distributed drive circuit also includes a first delay compensation unit 6, which is arranged in the control circuit 1. The first delay compensation unit 6 is used to compensate the driving delay of the drive circuit, as shown in FIG. 6.

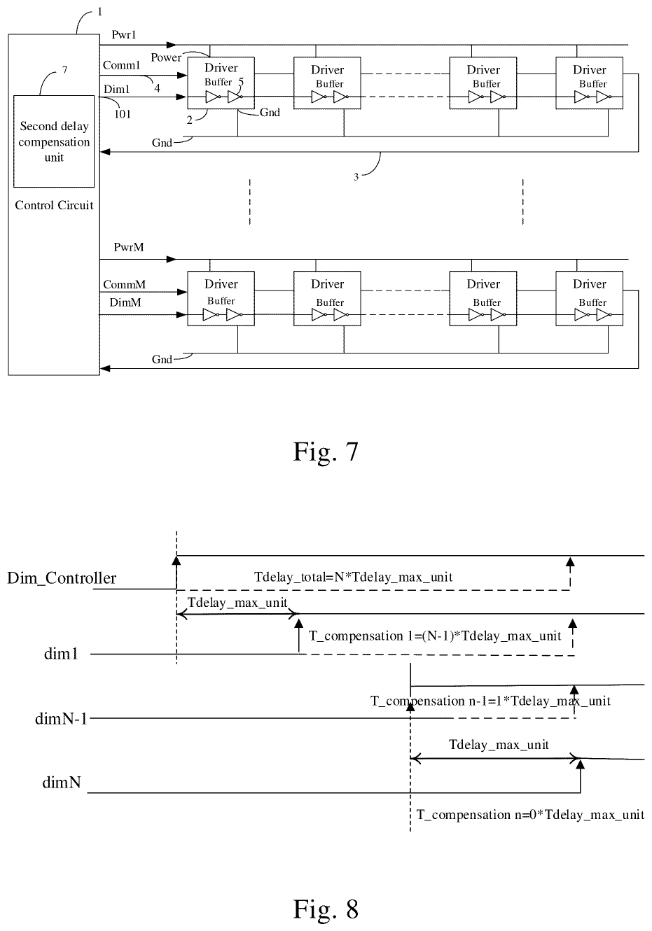

In an embodiment, on the basis that the buffer component is built in the drive circuit, the delay compensation unit may also be arranged in the control circuit. Specifically, the distributed drive circuit also includes a second delay compensation unit 7, which is arranged in the control circuit 1; the second delay compensation unit 7 is used to compensate the driving delay of the drive circuit, as shown in FIG. 7.

In an embodiment, when the delay compensation unit is arranged in the control circuit, it can be realized in the following ways: the control circuit 1 can preset a Tdelay_max_unit for each drive circuit 2 in advance, as shown in FIG. 8. The actual delay of each drive circuit should be less than this value, and each drive circuit calculates the time to be compensated according to its own device number (device ID N).

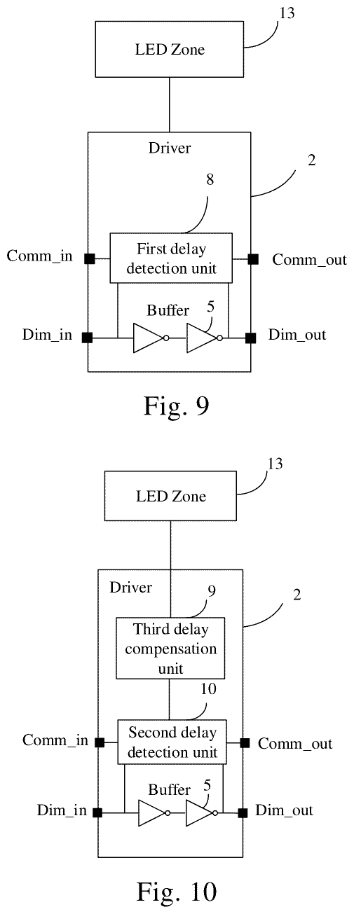

In an embodiment, besides the second delay compensation unit, the first delay detection unit 8 may be further included, and the first delay detection unit 8 is in one-to-one correspondence with the drive circuit. The first delay detection unit 8 is used to detect the delay of the control signal and command signal of the corresponding drive circuit, and feed back the detection value to the second delay compensation unit 7, allowing the second delay compensation unit 7 to compensate the driving delay of the drive circuit according to the detection value, as shown in FIG. 9.

In an embodiment, the first delay detection unit 8 can be connected in series in the serial communication line, as shown in FIG. 9. This allows the detection value to be transmitted to the read-back line via the serial communication line, and then the detection value can be fed back to the control circuit via the read-back line.

The delay detection unit can detect the delay in real time, and the delay compensation is more accurate, so that the dimming quality is better. Alternatively, the delay detection unit may not be provided, and the delay compensation of the delay compensation unit may be determined according to experience and may be a preset value.

In an embodiment, on the basis that the buffer component is built in the drive circuit, the delay compensation unit may also be arranged in the drive circuit. Specifically, the distributed drive circuit also includes a third delay compensation unit 9, which is in one-to-one correspondence with the drive circuit 2, as shown in FIG. 10. The third delay compensation unit 9 is used to compensate the driving delay of the corresponding drive circuit.

In an embodiment, besides the third delay compensation unit, a second delay detection unit 10 may be further included, which is in one-to-one correspondence with the drive circuit 2. The output end of the second delay detection unit 10 is connected with the input end of the third delay compensation unit, and the input end of the second delay detection unit is connected with the input end and output end of the buffer respectively, as shown in FIG. 10. The second delay detection unit is used to detect the delay of the control signal and command signal of the corresponding drive circuit, and feed back the detection value to the third delay compensation unit, so that the third delay compensation unit can compensate the driving delay of the drive circuit according to the detection value.

In an embodiment, the second delay detection unit 10 is also connected in series with the serial communication line 4, as shown in FIG. 10. In this way, the detection value can be transmitted to the read-back line via the serial communication line, and then the detection value can be fed back to the control circuit via the read-back line.

Specifically, the serial communication line can also be used to transmit addressing signals, which is convenient for the control circuit to assign addresses to the drive circuit in addressing mode.

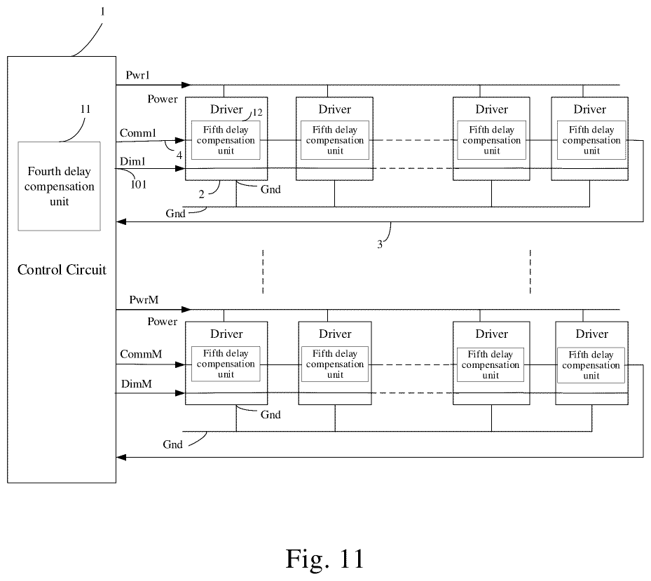

In an embodiment, the delay compensation may be arranged in both the control circuit and the drive circuit. Specifically, the distributed drive circuit also includes a fourth delay compensation unit 11 and a fifth delay compensation unit 12, as shown in FIG. 11. The fourth delay compensation unit 11 is arranged in the control circuit 1. The fifth delay compensation unit 12 is in one-to-one correspondence with the drive circuit 2, and the fifth delay compensation unit 12 is arranged in the drive circuit 2. The fourth delay compensation unit 11 and the fifth delay compensation unit 12 are configured to jointly compensate the driving delay of the drive circuit 2.

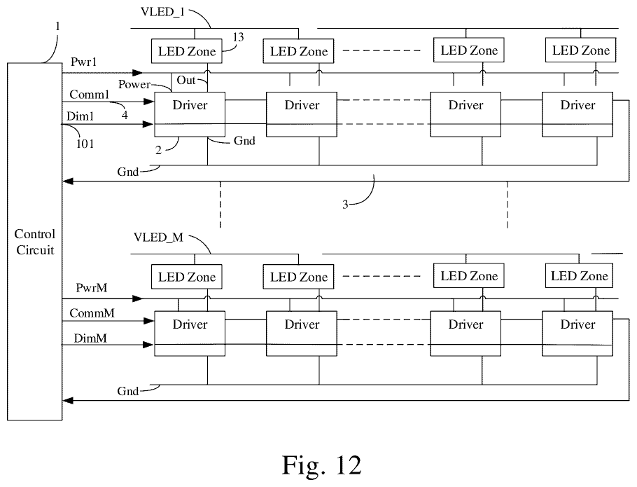

In an embodiment, a display device with a distributed drive circuit is provided, which includes a distributed drive circuit and an LED zone array. The LED zone array includes a plurality of groups of LED zones, and each group of LED zones includes a plurality of LED zones 13. The LED zone 13 is in one-to-one correspondence with the drive circuit 2, as shown in FIG. 12. The distributed drive circuit is the one described in any of the above embodiments.

The display device may further include a VLED line (e.g., VLED_1 . . . VLED_M), a power communication line Pwr (e.g., Pwr1 . . . PwrM), and a ground line Gnd. The VLED line is used to supply power to the LED zone, the power communication line Pwr is used to supply power to the drive circuit, and the ground line Gnd provides a grounding path for the LED zone and the drive circuit 2.

In this specification, descriptions referring to the phrases “an implementation”, “an embodiment”, “a specific implementation process” and “an example” mean that specific features, structures, materials or characteristics described in connection with the embodiment or example are included in at least one embodiment or example of the present invention. In this specification, the schematic expressions of the above phrases do not necessarily refer to the same embodiment or example. Moreover, the specific features, structures, materials or characteristics described may be combined in any one or more embodiments or examples in a appropriate manner.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the scope of the technical solutions of each embodiment of this application.

1. A distributed drive circuit, comprising a control circuit, a drive circuit array, a command control interface and a read-back line; wherein
the drive circuit array comprises a plurality of drive circuit groups, each drive circuit group comprises a plurality of drive circuits;
the control circuit is used for sending a control signal and a command signal to the drive circuit;
the command control interface is arranged in the control circuit, and the command control interface is used for outputting the control signal and command signal sent by the control circuit for transmission to the drive circuit;
the command control interface is in serial connection with the plurality of drive circuits in each drive circuit group;
the drive circuit is used for driving LED in response to the control signals, and is also used for generating read-back data to the control circuit in response to the command signal; and
the read-back line is used for transmitting the read-back data generated by the drive circuit back to the control circuit.

2. The distributed drive circuit of claim 1, further comprising serial communication lines, wherein the serial communication line is in one-to-one correspondence with the drive circuit group; and
the control circuit, the serial communication line and the read-back line form a loop, and the drive circuit of each group is connected in series in the serial communication line.

3. The distributed drive circuit of claim 1, further comprising a buffer component, wherein the buffer component is connected in a control command line, and is used for enhancing a driving capability of the control circuit.

4. The distributed drive circuit of claim 3, wherein the buffer component comprises a plurality of buffers, and the buffer is in one-to-one correspondence with the drive circuit group; and
the buffer is arranged between the control circuit and a first drive circuit of each drive circuit group.

5. The distributed drive circuit of claim 3, wherein the buffer component comprises a plurality of buffers, and the buffer is in one-to-one correspondence with the drive circuit group; and
the buffer is arranged in the drive circuit.

6. The distributed drive circuit of claim 3, wherein a driving delay of the drive circuit is less than a preset value.

7. The distributed drive circuit of claim 4, further comprising a first delay compensation unit arranged in the control circuit;
wherein the first delay compensation unit is used for compensating the driving delay of the drive circuit.

8. The distributed drive circuit of claim 5, further comprising a second delay compensation unit arranged in the control circuit;
wherein the second delay compensation unit is used for compensating the driving delay of the drive circuit.

9. The distributed drive circuit of claim 8, further comprising a first delay detection unit, wherein the first delay detection unit is in one-to-one correspondence with the drive circuit; and
the first delay detection unit is used to detect a delay of the control signal and command signal of the corresponding drive circuit, and feed back a detection value to the second delay compensation unit, enabling the second delay compensation unit to compensate the driving delay of the drive circuit according to the detection value.

10. The distributed drive circuit of claim 5, further comprising a third delay compensation unit, wherein the third delay compensation unit is in one-to-one correspondence with the drive circuit; and
the third delay compensation unit is used for compensating the driving delay of the corresponding drive circuit.

11. The distributed drive circuit of claim 10, further comprising a second delay detection unit, wherein the second delay detection unit is in one-to-one correspondence with the drive circuit; and
an output end of the second delay detection unit is connected with an input end of the third delay compensation unit, and an input end of the second delay detection unit is connected with an input end and an output end of the buffer; and
the second delay detection unit is used to detect the delay of the control signal and command signal of the corresponding drive circuit, and feed back the detection value to the third delay compensation unit, enabling the third delay compensation unit to compensate the driving delay of the drive circuit according to the detection value.

12. The distributed drive circuit of claim 5, further comprising a fourth delay compensation unit and a fifth delay compensation unit; wherein
the fourth delay compensation unit is arranged in the control circuit;
the fifth delay compensation unit is in one-to-one correspondence with the drive circuit, and the fifth delay compensation unit is arranged in the drive circuit; and
the fourth delay compensation unit and the fifth delay compensation unit are configured to jointly compensate the driving delay of the drive circuit.

13. A display device with a distributed drive circuit, comprising a distributed drive circuit and an LED zone array; wherein
the LED zone array comprises a plurality of groups of LED zones, and each group of LED zones comprises a plurality of LED zones;
the LED zone is in one-to-one correspondence with the drive circuit; and
the distributed drive circuit is the distributed drive circuit of claim 1.
